(19) United States
(12) Patent Application Publication
(10) Pub. No.: US 2004/0217069 A1
(43) Pub. Date: Nov. 4, 2004

(54) Rotor assembly for the collection, separation, and sampling of rare blood cells

(75) Inventor: Richard L. Columbus, Rochester, NY (US)

Correspondence Address: Stephen B. Salai, Esq., Harter, Secrest & Emery LLP, 1600 Bausch & Lomb Place, Rochester, NY, 14604-2711, US

(73) Assignee: Immunicon Corp., Huntingdon Valley, PA (US)

(21) Appl. No.: 10/834,792

(22) Filed: Apr. 29, 2004

Related U.S. Application Data
(60) Provisional application No. 60/466,484, filed on Apr. 30, 2003.

(51) Int. Cl. B01D 33/15

(52) U.S. Cl. 210/782; 494/45

(57) ABSTRACT

The rotor assembly is provided for the separation and harvesting of rare cells in a blood sample. A displacing fluid reservoir is located at least partially radially inward of a centrifuging chamber, wherein a displacing fluid of a greater density than the fluid in the centrifuging chamber is retained in the displacing fluid reservoir. Upon rotation of the rotor assembly, the displacing fluid is allowed to pass into the centrifuging chamber, typically at an outer periphery of the centrifuging chamber, so as to urge the latest separated component in the centrifuging chamber through an outlet port coincident with the axis of rotation of the rotor assembly.

### CROSS-REFERENCE TO RELATED APPLICATIONS

The present application claims the benefit of U.S. Provisional Application No. 60/466,484, filed Apr. 30, 2003.

### STATEMENT REGARDING FEDERALLY SPONSORED RESEARCH OR DEVELOPMENT

Not applicable.

### REFERENCE TO A “SEQUENCE LISTING”

Not applicable.

### BACKGROUND OF THE INVENTION

1. Field of the Invention

The present invention relates to the collection, separation, and sampling of biological fluids and, more particularly, to the selective expression of separated blood components during centrifugation by exposure to a relatively dense displacing fluid.

2. Description of Related Art

Research has shown that numerous normal and abnormal conditions are evidenced in the blood. However, such evidence is often in trace amounts, thereby rendering detection difficult. Further, the trace amounts are often physically dominated by other constituents of the blood.

Blood consists of a number of components having different characteristics and uses. The separation of a single unit of donated whole blood into its components is typically accomplished by use of differential sedimentation. The principal components thus recovered are red cells, usually concentrated as packed red cells (PRC), a platelet suspension, usually concentrated as platelet concentrate (PC), and plasma.

There are two principal methods for separation of whole blood into components. In one method, the whole blood is centrifuged to produce a supernatant PRP fraction and a sediment PRC fraction, with a transition zone material in between, generally known as the buffy coat, which contains leukocytes, as well as platelets, red cells, and plasma.

In an alternative method, the whole blood is centrifuged to produce a supernatant platelet-poor plasma (PPP) fraction and a sediment PRC fraction, with a transition zone material, the buffy coat, therebetween, which contains the majority of platelets, as well as leukocytes, red cells, and plasma.

Drawbacks of both techniques include the potential for contamination with red cells and/or leukocytes. With respect to red cell contamination, the presence of red cells in some blood components (e.g., PC) is so undesirable that the technicians operating the blood processing equipment during the separation of components typically constantly monitors the process and clamps the connecting tube between the blood bags when, in their subjective judgment, as much fluid has been transferred as is possible, without allowing red cells to pass into a downstream satellite bag. This is a labor-intensive and time-consuming operation.

Red cell contamination presents an additional dilemma. Since platelets and plasma are valuable, blood bank personnel may attempt to express more of the PRP or the supernatant platelet-containing fraction into the satellite bag prior to stopping the flow from the collection bag. This is counterproductive in that the expressed fluid in the satellite bag may be contaminated by red cells so that the expressed fluid may have to be discarded or recentrifuged, both of which increase operating costs and are labor intensive. As a result, personnel may prematurely stop the flow of the platelet-containing fluid before it has been fully expressed. These techniques may also produce leukocyte contaminated components.

In view of these problems, it is difficult to eliminate red cell and leukocyte contamination while maximizing the yield of the various blood components in the transition zone material or the buffy coat. For example, since it may be difficult to easily or efficiently separate the platelets, plasma, and red blood cells, the buffy coat may be partially or entirely discarded, resulting in reduced yields of valuable blood components.

The loss of platelets is especially significant, since the discarded portion may include the most desirable platelets, i.e., the newly formed platelets. These platelets are larger and are generally believed to be more active. Since the younger platelets are larger, they tend to sediment faster during centrifugation, so they may be concentrated as in one of the described techniques in the bottom of the PRP and in the buffy coat. Accordingly, since portions of the platelet-containing fluid may be either processed as part of the red cells, or discarded, this represents a significant loss of the more desirable platelets.

For example, the buffy coat may be discarded after expression of the PRP and PRC layers or may be processed with the PRC. Similarly, after forming a buffy coat between PPP and PRC layers, the lower portion of the bully coat may be processed with the PRC, or the buffy coat may be incompletely expressed to prevent red cell contamination of the platelets. Furthermore, the lower portion of the supernatant platelet-containing fraction may be incompletely expressed to avoid red cell contamination from the sediment fraction, and this may decrease the yield of the platelets.

These problems are magnified when the available volume of blood is reduced. Additionally, processing of blood to provide blood components may lead to the presence of gas or air, in particular oxygen, in the blood components or in the storage container. This may lead to an impairment of the quality of the blood components.

Accordingly, the previous methods reflect a generally unsatisfying compromise between the need to maximize the yield of the valuable blood components from blood samples, while minimizing the effort and expense involved.

Thus, there is a need for a method and system for alleviating the above-described problems while providing maximum purity and a higher yield of superior quality blood components. In particular, there is a need for an easily used system and method for recovery and treatment of the transition zone material or the buffy coat which increases yield and reduces the presence of gas while delivering a greater proportion of viable and physiologically active platelets.

There is also a need for a method and system for efficiently identifying the blood components, such as the transition zone material or the buffy coat, that maximizes the amount of fluid that can be recovered.

Moreover, there is also a need for a method and system that reduces operator involvement.

### BRIEF SUMMARY OF THE INVENTION

The present invention provides a rotor assembly for the collection, separation, and expression of individual liquid components or phases, such as that found in whole blood. The rotor assembly finds particular application in the harvesting of rare cells, often associated with other indicators of cancerous activity within the body and especially those cells associated with the buffy coat.

The rotor assembly provides for the expression of separated components during rotation of the rotor, wherein an aspirating mechanism, which is not rotating relative to the rotor, can be employed to harvest the separated liquid layers.

The present rotor assembly can be used to provide a method for selectively expressing a liquid from a centrifuging chamber rotating about an axis by passing a volume of a displacing fluid from a displacing fluid reservoir located in the rotor radially inward of at least a portion of the liquid in the centrifuging chamber, the displacing fluid having a greater density than the liquid. The method can further include continuously exposing the displacing fluid to an ambient pressure; and selectively actuating a dispensing valve to pass liquid from the centrifuging chamber. In addition, the method can further encompass selectively exposing the displacing fluid to an ambient pressure to control passage of the displacing fluid into the centrifuging chamber; locating the displacing fluid reservoir above the centrifuging chamber; locating the displacing fluid reservoir below the centrifuging chamber; and connecting a sampling stem to the rotor assembly.

The present rotor assembly is selected for rotation about an axis to separate components in a liquid and selectively express the components from the rotor assembly during rotation of the rotor assembly, wherein the rotor assembly includes a centrifuging chamber having an inlet port, a spaced outlet port and a coupling port; a displacing fluid reservoir, at least a portion of the displacing fluid reservoir being radially inward of the coupling port; and a coupling valve fluidly connected to the coupling port and the displacing fluid reservoir.

In a further construction, the rotor assembly can include a centrifuging chamber having an inlet port, a spaced outlet port and a coupling port; a displacing fluid reservoir; and a coupling valve fluidly connected to the coupling port and the displacing fluid reservoir. The displacing fluid in the displacing fluid reservoir can be selected to have a greater density than the liquid in the centrifuging chamber. In the rotor assembly, at least a portion of the displacing fluid reservoir is radially inward of a portion of the centrifuging chamber.

The rotor assembly provides a centrifuging chamber for retaining a volume of liquid, the centrifuging chamber including a dynamic (or variable) maximum radial dimension, the maximum radial dimension being variable during rotation of the rotor about the axis.

The rotor assembly is constructed for rotation about an axis to separate components of a retained liquid by density into component layers to form at least one liquid-to-liquid boundary layer located at a given radial distance from the axis, and includes the centrifuging chamber having a maximum radial dimension; and means for decreasing the maximum radial dimension to decrease the given radial distance.

### BRIEF DESCRIPTION OF THE SEVERAL VIEWS OF THE DRAWING(S)

FIG. 1 is schematic of the rotor assembly in relation to a patient and transport to a centrifuge.

FIG. 2 is a top plan view of a centrifuge to process the rotor assembly.

FIG. 3 is a side elevational view of the centrifuge of FIG. 2.

FIG. 4 is a cross-sectional view of a first configuration of the rotor assembly retaining a volume of liquid to be separated.

FIG. 5 is a cross-sectional view of the rotor assembly of FIG. 4 without the volume of liquid to be separated.

FIG. 6 is a cross-sectional view of an upper plate assembly of the rotor assembly of FIG. 4.

FIG. 7 is a cross-sectional view of a lower plate assembly of the rotor assembly of FIG. 4.

FIG. 8 is a cross-sectional view of an upper shell of the lower plate assembly of the rotor assembly of FIG. 4.

FIG. 9 is a cross-sectional view of a lower shell of the lower plate assembly of FIG. 4.

FIG. 10 is a top plan view of the lower plate assembly.

FIG. 11 is a schematic view of alternative removable sampling stems for use with the rotor assembly.

FIG. 12 is a cross-sectional view showing a rotor assembly in a caddy prior to rotation.

FIG. 13 is a cross-sectional view of the rotor assembly and caddy of FIG. 12 during expression of separated constituents.

FIG. 14 is a cross-sectional view of an alternative configuration of the rotor assembly.

FIG. 15 is an exploded cross-sectional view of an upper plate assembly of the rotor assembly of FIG. 14.

FIG. 16 is a cross-sectional view of the upper plate assembly of FIG. 14.

FIG. 17 is an exploded cross-sectional view of a lower plate assembly of the rotor assembly of FIG. 14.

FIG. 18 is a cross-sectional view of the lower plate assembly of FIG. 17.

FIG. 19 is a bottom plan view of the upper plate assembly of FIG. 16.

FIG. 20 is a cross-sectional view of an alternative upper plate assembly.

FIG. 21 is a representative view of a closure cover for the sampling stem.

FIG. 22 is an exploded view of a valve system for exposing the displacing fluid to the centrifuging reservoir.

FIG. 23 is a top plan view of a spring bias valve of FIG. 22.

FIGS. 24-27 are a schematic series showing operation of the rotor assembly of FIG. 14.

FIG. 286 is a cross-sectional view of a further embodiment of the rotor assembly.

FIG. 29 is a schematic of the rotor assembly of FIG. 28.

FIG. 30 is a schematic of the sampling stem showing representative dimensions.

FIG. 31 is a top plan view of a representative distribution plate for the rotor assembly of FIG. 28.

FIG. 32 is a bottom plan view of the representative distribution plate of FIG. 31.

FIGS. 33-35 are schematics of operation of the rotor assembly of FIG. 28.

### DETAILED DESCRIPTION OF THE INVENTION

A rotor assembly 10 of the present invention provides for the rapid separation of blood components under centrifugal force and the controlled expression or extraction of the separated components. Thus, the rotor assembly 10 can be employed for collecting blood from a patient and controllably harvesting separated components of the blood while under centrifugal force.

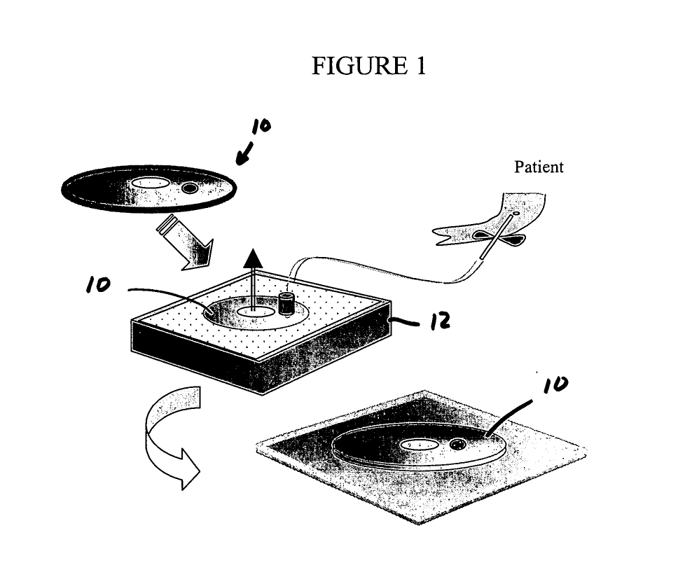

As seen in FIG. 1, the rotor assembly 10 can be used to collect blood from a patient. The rotor assembly 10 can be used in conjunction with an optional caddy 12, wherein blood is drawn from the patient and introduced into the rotor assembly. The rotor assembly 10 can be transported either locally (within the facility) or remotely to a processing center either with or without the caddy 12.

The rotor assembly 10 can accommodate any of a variety of fluid volumes for separation. For purposes of description, a representative capacity for the rotor assembly 10 is set forth in terms of collecting approximately 30 ml to 50 ml of fluid.

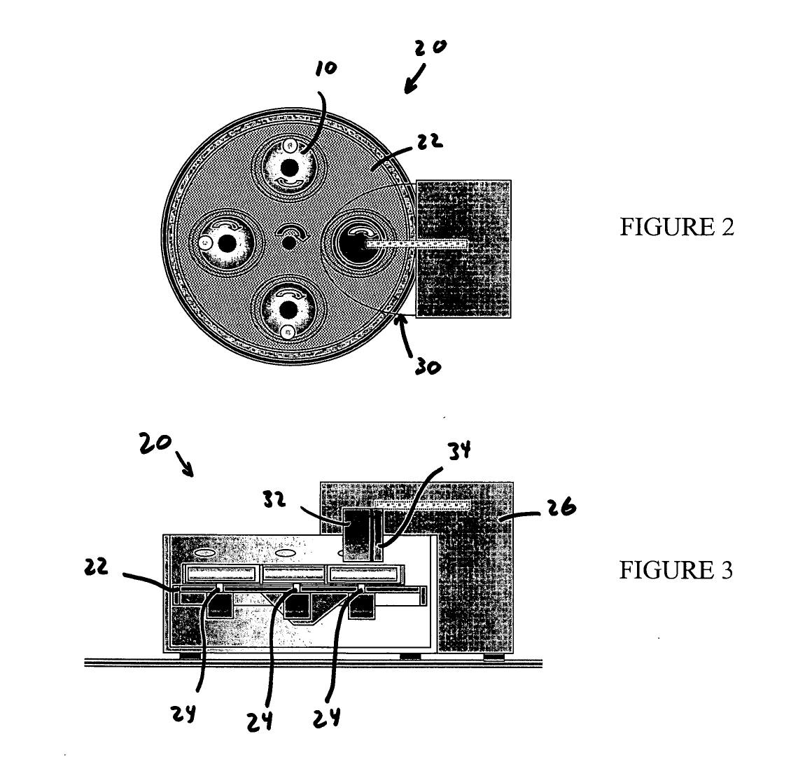

The processing center provides the capacity to rotate the rotor assembly 10 and collect the desired blood components. Referring to FIGS. 2 and 3, a centrifuge 20 is shown for rotating the rotor assembly 10 to separate the blood components within the rotor assembly and selectively extract the components from the rotor assembly during rotation of the rotor assembly.

Generally, the centrifuge 20 includes a primary platter 22 rotatable about a primary axis. The primary platter 22 supports at least one and preferably a plurality of independent rotatable spindles 24. A controller 26 is embedded in the centrifuge or operably connected to the centrifuge to control the primary platter 22 and each spindle 24. The controller 26 can be a dedicated processor, or can include software on a separate computer, which in turn is operably connected to the centrifuge 20. The spindles 24 are selected to engage a rotor assembly 10 (or caddy 12) to controllably rotate the rotor assembly about the axis of the spindle;

The centrifuge 20 includes a docking station 30 for interfacing with an aligned rotor assembly 10 on the primary platter 22. The docking station 30 can include a variety of components including an aspirator 32 (or extraction duct), multiple receiving vessels as well as sensors 34 such as optical, electrical or chemical sensors. The sensors 34 can be used to determine characteristics or process stages of the blood within the rotor assembly 10, particularly during rotation of the rotor assembly.

Generally, the primary platter 22 rotates at a low non-centrifuging speed to selectively operably align a given spindle 24 (and associated rotor assembly 10) with the docking station 30. A given spindle 24 is rotated at a centrifuging speed to induce separation of the liquid components of the fluid retained with the corresponding rotor assembly 10. In a preferred construction, each spindle 24 can be independently rotated at selected speed, thereby providing a centrifugation that can be optimized for the fluid in the corresponding rotor assembly. The rotation of each rotor assembly 10 on the primary platter 22 can be monitored and controlled by any of a variety of mechanisms including timing, optic or electrical sensors.

It is also contemplated the rotor assemblies 10 can cooperatively engage the centrifuge 20 by a transfer assembly, wherein the transfer assembly receives a sample container and transports the container along a horizontal or substantially horizontal travel path to be operably disposed on the primary platter.

The centrifuge 20 can process at least a first and a second rotor assembly 10, and includes a frame; the incremental positioning primary platter 22 rotatably mounted to the frame for rotation about a primary axis; at least a first and a second rotatable centrifuging spindle 24 connected to the primary platter for orbiting about the primary axis, the first and second spindle independently rotatable and selected to releasably engage the first and second rotor assembly, respectively; the aspirating assembly 32 connected to the frame for selectively aspirating liquid from one of the first and the second rotor assembly during rotation of the rotor assembly with the respective spindle; and a controller operably connected to the primary platter, the first rotatable spindle and the second rotatable spindle to selectively operably align the first spindle with the aspirating assembly. The sensor 34 can be connected to the controller and employed for sensing a parameter of liquid in the rotor assembly during rotation of the rotor assembly. The primary platter 22 and the first and second spindle 24 can be configured to horizontally introduce the first rotor assembly and the second rotor assembly to the centrifuge.

It is also contemplated the aspirating assembly 32 can include an intermediate collection vessel fluidly connectable to one of the first and the second rotor assembly. Further, the intermediate collection vessel can be of a disposable or single use construction.

Although it is understood any other variety of liquids having components of different density or specific gravity can be separated under centrifugation in the rotor assembly 10, for purposes of description, the fluid to be separated will be described in the processing of blood.

The term blood encompasses biological fluids including but not limited to any treated or untreated fluid associated with living organisms, particularly blood, such as whole blood, warm or cold blood, and stored or fresh blood; treated blood, such as blood diluted with a physiological solution, including but not limited to saline, nutrient, and/or anticoagulant solutions; one or more blood components, such as platelet concentrate (PC), platelet-rich plasma (PRP), fresh frozen plasma (FFP), platelet-free plasma, platelet-poor plasma (PPP), plasma, plasma derivatives such as cryoprecipitate, plasma fractionation products, and factor concentrates; packed red cells (PRC), or buffy coat (BC); and analogous blood products derived from blood or a blood component or derived from bone marrow. The biological fluid can include leukocytes or can be treated to remove leukocytes. As used herein, blood product or biological fluid refers to the components described above and to similar blood products or biological fluids obtained by other means and with similar properties. However, it is expressly understood the invention is not limited to processing blood, and can be employed with any liquid having components separable under centrifugal force.

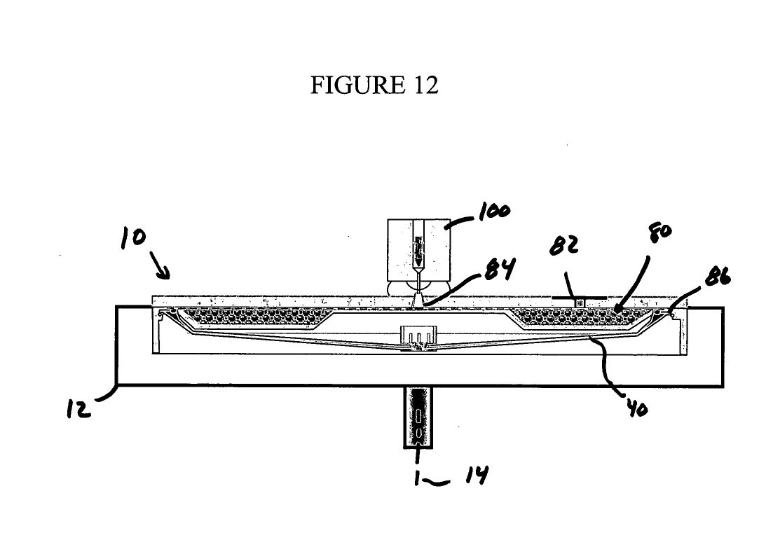

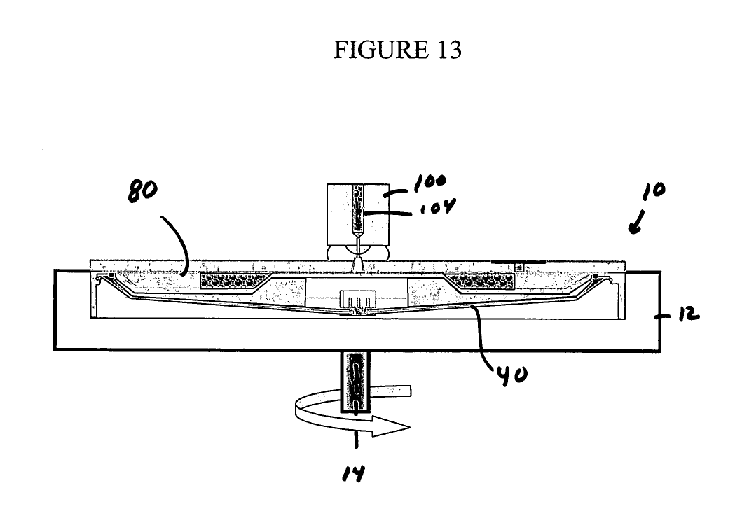

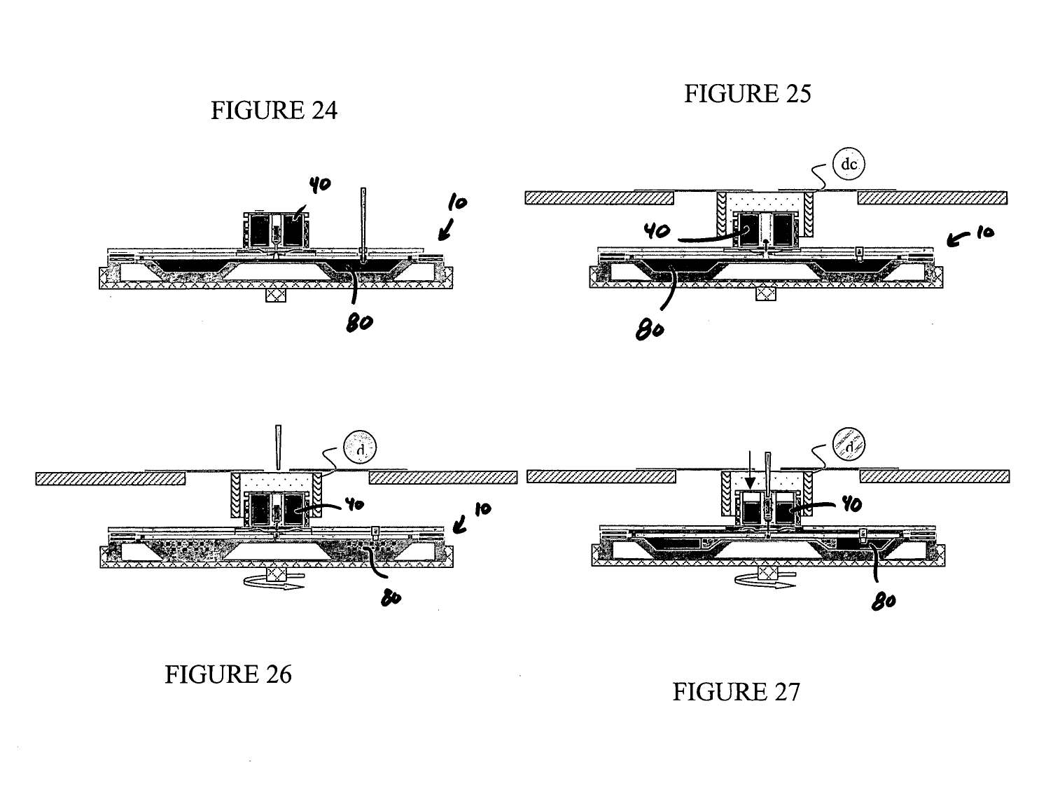

Referring to FIGS. 12, 13, 14, 24-26, and 34-35, the rotor assembly 10 is constructed for rotation about an axis 14, such as the axis of the spindle 24, and includes a displacing fluid reservoir 40 and a centrifuging chamber 80. The axis 14 may also be referred to as the axis of rotation for the rotor assembly 10. The rotor assembly 10 is constructed so that at least a portion of the displacing fluid reservoir 40 is located radially inward (with respect to the axis of rotation) of the centrifuging chamber 80.

That is, at least a portion of the centrifuging chamber 80 is located radially outward of at least a portion of the displacing fluid reservoir 40. Preferably, the displacing fluid reservoir 40 and the centrifuging chamber 80 are constructed to be symmetrical about the axis of rotation. However, it is understood that the configuration of the displacing fluid reservoir 40 and the centrifuging chamber 80 can be configured in conjunction with counterweights or counterbalances, such that the displacing fluid reservoir and the centrifuging chamber are not symmetrical with respect to the axis of rotation.

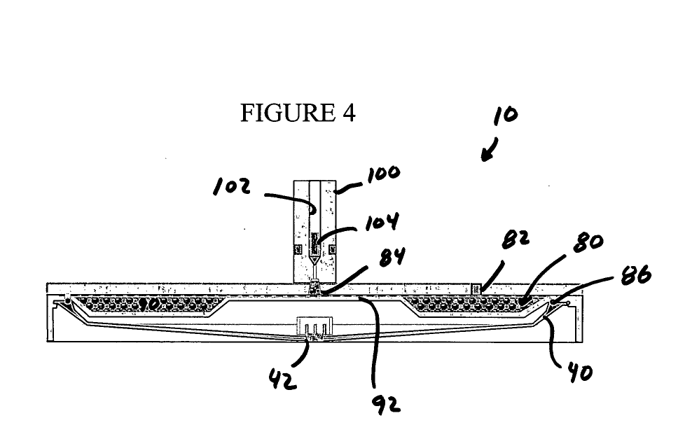

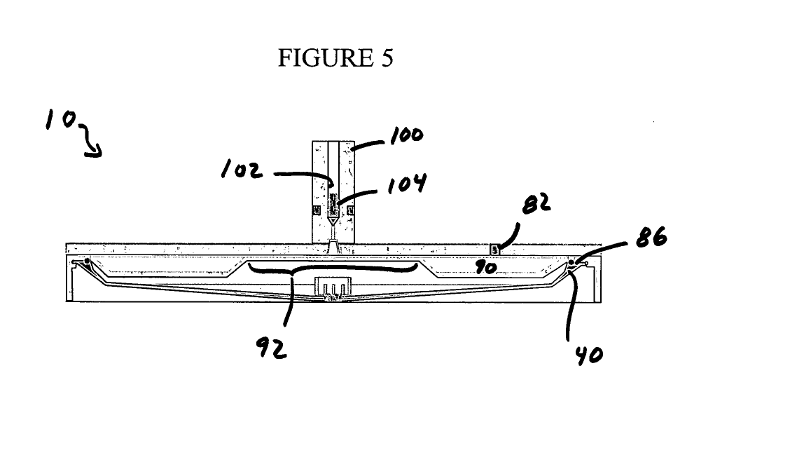

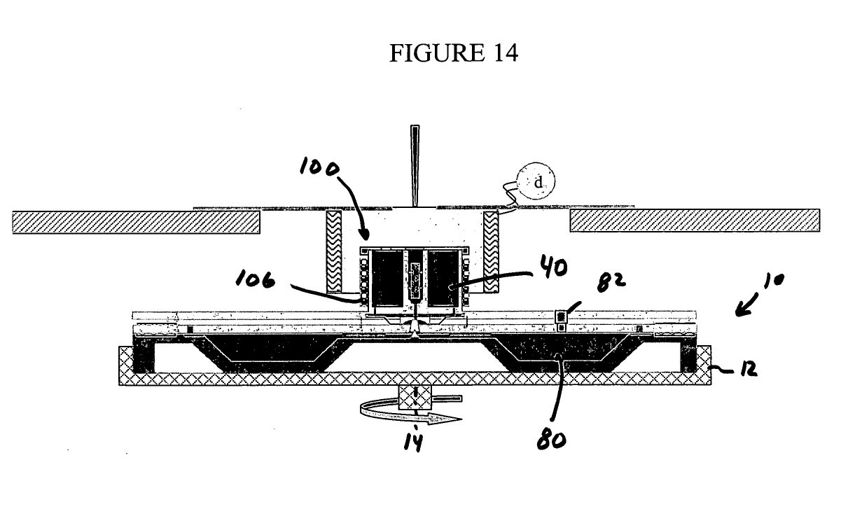

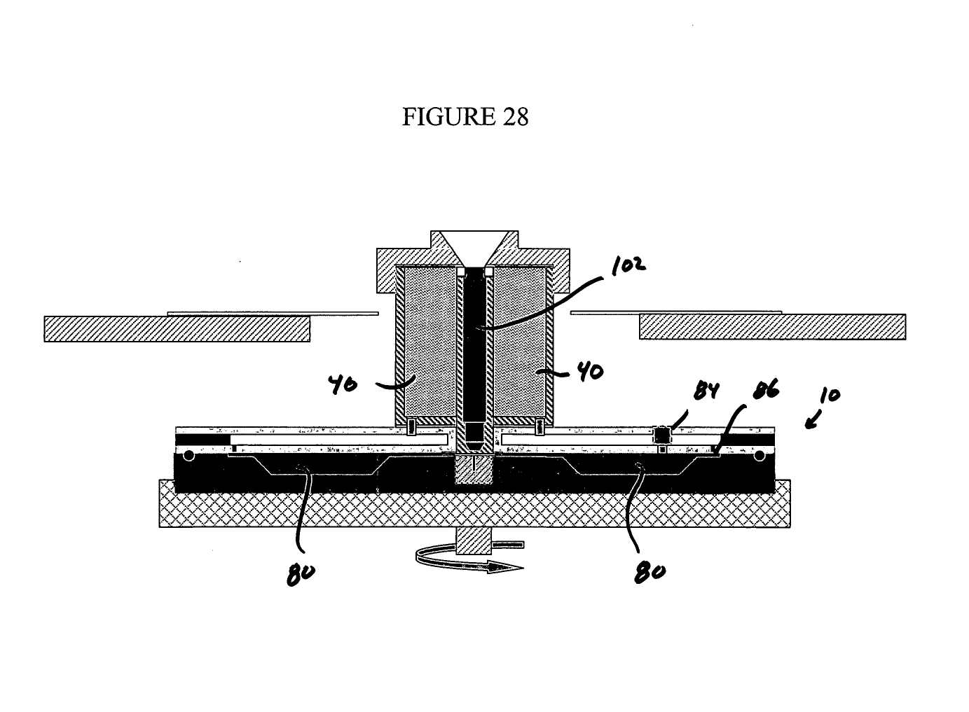

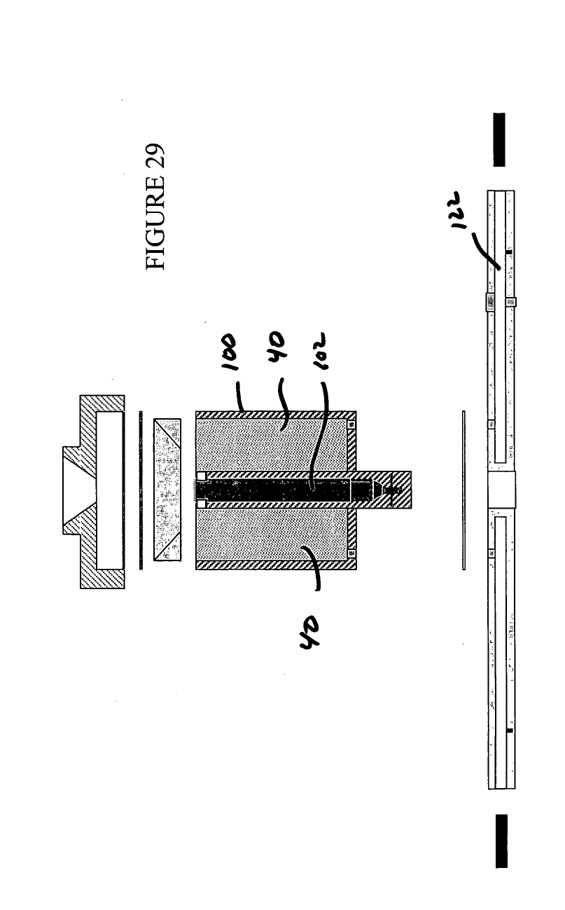

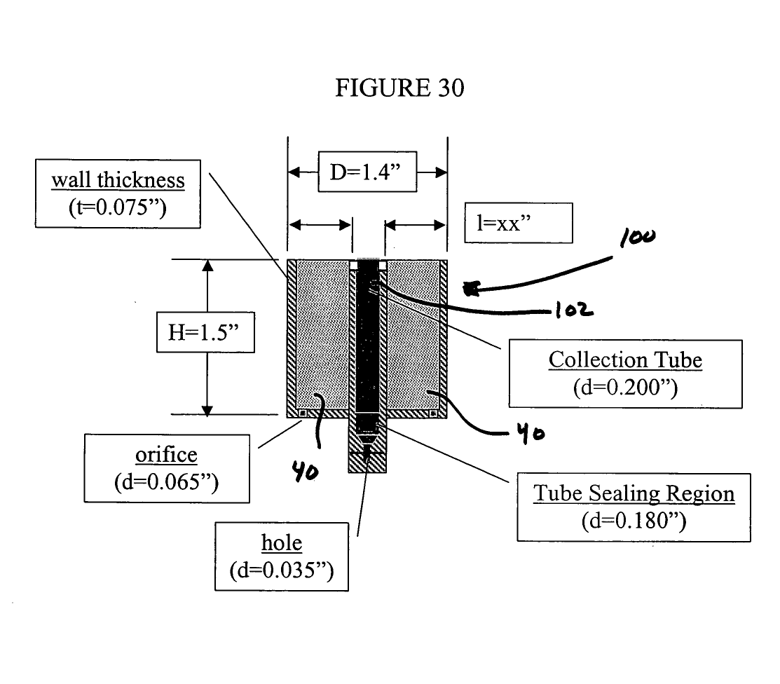

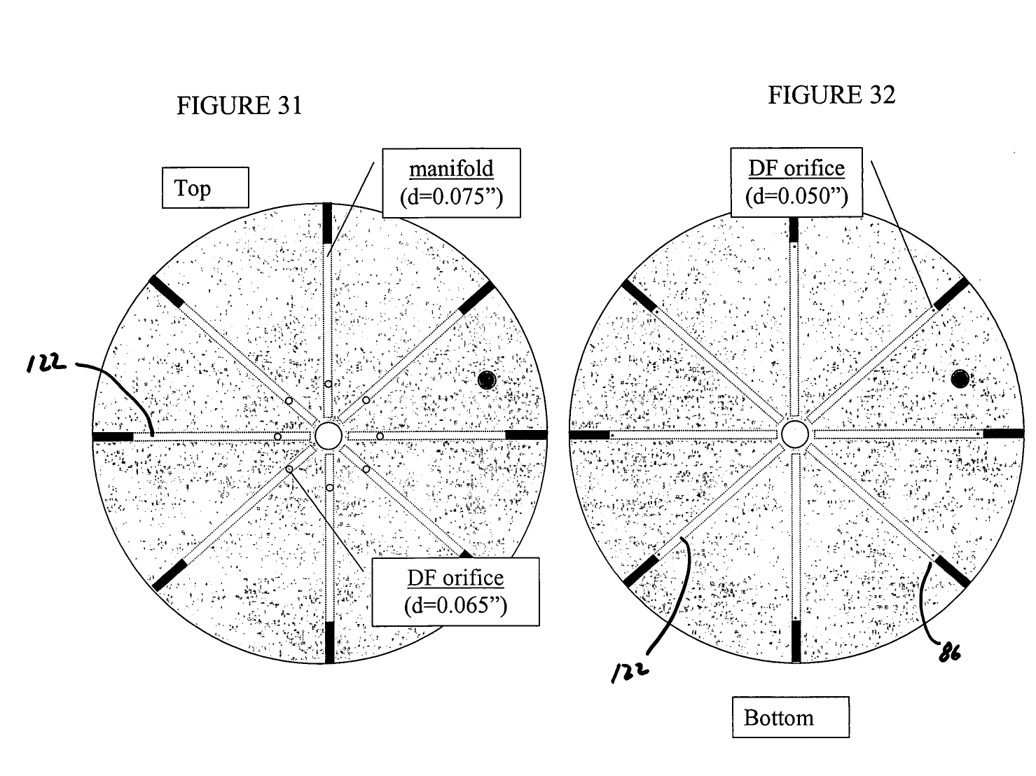

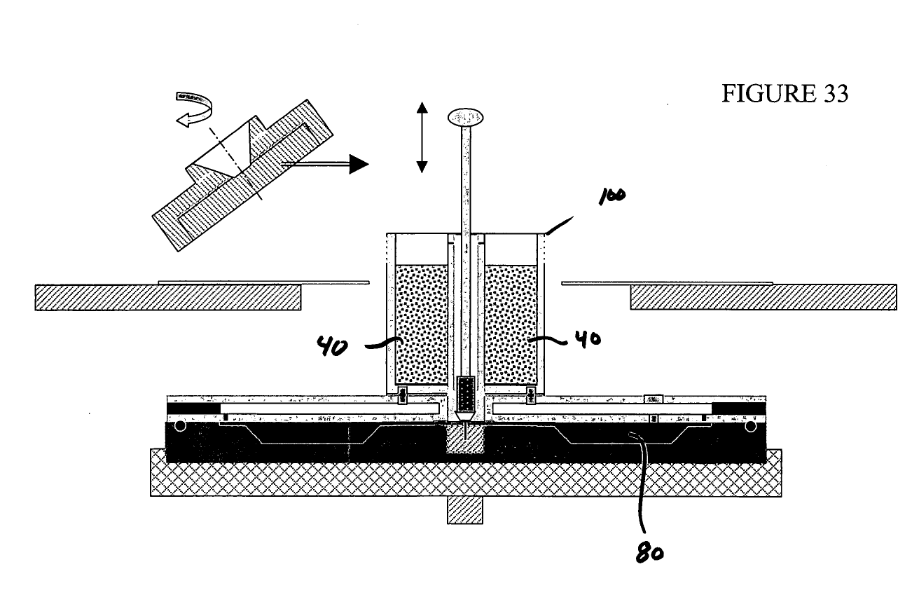

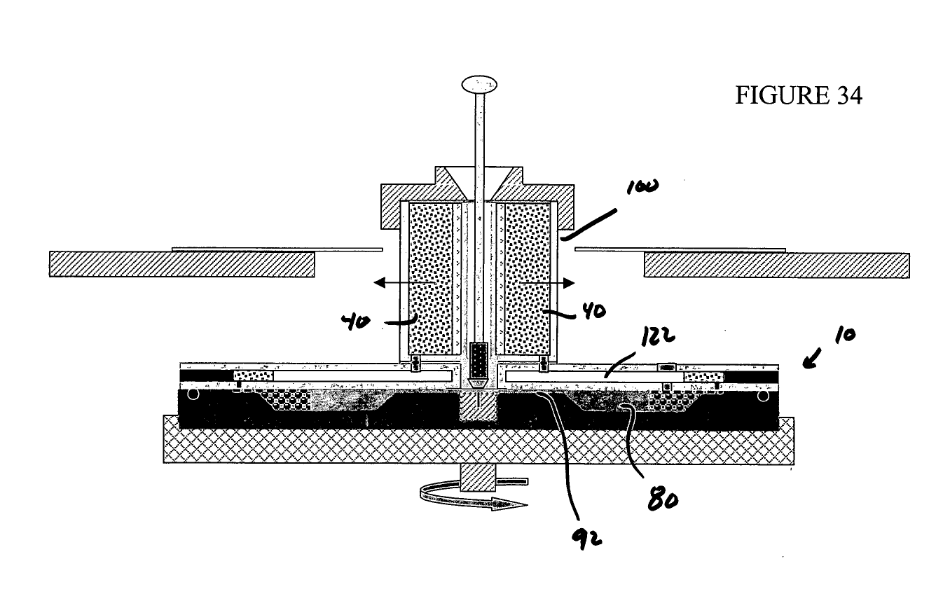

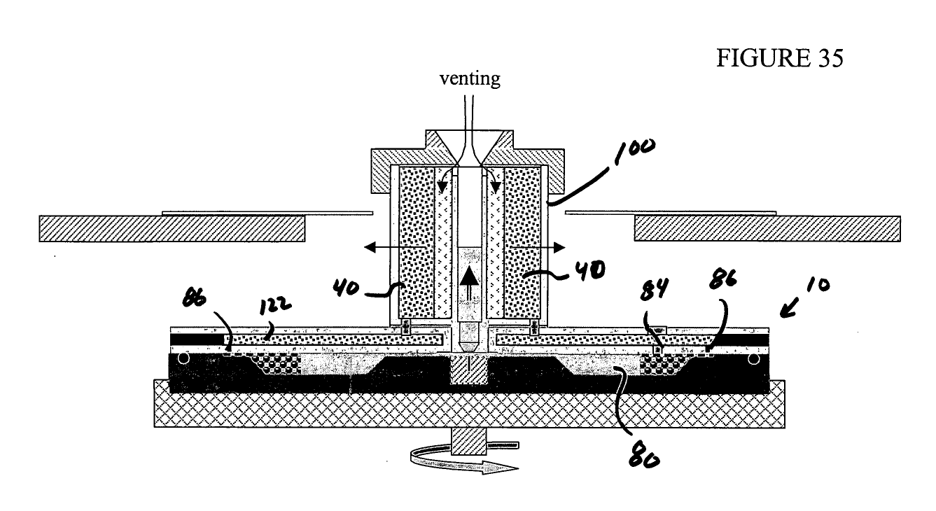

The displacing fluid reservoir 40 can be located above the centrifuging chamber 80 as seen, for example, in FIGS. 14-16, 24-27, and 33-35 or below the centrifuging chamber (along the axis of rotation of the rotor assembly) as seen, for example, in FIGS. 4, 5, 12, and 13, such that in either configuration, at least a portion of the displacing fluid reservoir is radially inward of the centrifuging chamber.

The displacing fluid reservoir 40 can be integrally formed with the rotor assembly 10, or can be a separately formed from modular component(s) that are affixed or connected to the rotor assembly, or can form a portion of the rotor assembly.

The displacing fluid reservoir 40 includes at least one vent 42. The vent 42 can be a continuous vent or a controlled vent. In one configuration, the vent 42 continuously vents to atmospheric pressure. In an alternative configuration, the vent 42 is controlled for selectively allowing venting to atmospheric pressure.

The displacing fluid reservoir 40 is sized to retain a volume of displacing fluid and preferably a volume of displacing fluid at least as great as the volume of liquid to be expressed from the centrifuging chamber 80.

The centrifuging chamber 80 is located radially outward of at least a portion of the displacing fluid reservoir 40. In one configuration, the centrifuging chamber 80 includes an inlet port 82 for introducing a fluid into the centrifuging chamber and an outlet port 84. In one configuration, the outlet port 84 is concentric with the axis of rotation 14 and, particularly, located on the axis of rotation.

It has been found advantageous to employ a separate inlet port 82 and outlet port 84 or the centrifuging chamber 80. The separate inlet port 82 and outlet ports 84 of the centrifuging chamber 80 allow the introduction of unseparated liquid, such as whole blood, without risk of contaminating separated components passing through the same orifice.

The inlet port 82 can include a self-healing seal, so as to allow penetration by a cannula and subsequent effective sealing upon withdrawal of the cannula. Self-healing seals are known in the art.

The centrifuging chamber 80 also includes a coupling port 86 providing fluid communication between the displacing fluid reservoir 40 and the centrifuging chamber. The coupling port 86 can have any of a variety of configurations including, but not limited to distribution channels, annular orifice, as well as discrete spaced flow paths.

Preferably, the coupling port 86 is at or near a maximum radial dimension of the centrifuging chamber 80. In addition, it is believed beneficial to employ a plurality of coupling ports 86 at the maximum radial dimension of the centrifuging chamber 80.

The centrifuging chamber 80 is a generally torroidal shape concentric with the axis of rotation 14 and symmetrical about the axis of rotation, wherein the centrifuging chamber includes or defines a main body 90 spaced from the axis of rotation. Thus, the axis of rotation 14 is circumscribed by the volume of liquid being spun. In one configuration, the centrifuging chamber 80 includes a gradient amplification zone 92 radially intermediate the outlet port 84 and the main body 90. The gradient amplification zone 92 has a smaller axial dimension than the main body 90 of the centrifuging chamber 80. The ratio of the radial dimension of the gradient amplification zone 92 to the main body 90 is selected to provide clear demarcation between adjacent separated components as the interfaces are disposed within the gradient amplification zone.

In the 30 to 50 ml configuration of the rotor assembly 10, the centrifuging chamber 80 has a volume of approximately 55 ml. The gradient amplification zone 92 has an axial dimension of approximately less than 20% of the radial dimension of the main body 90.

In certain configurations, fluid communication between the displacing fluid reservoir 40 and the centrifuging chamber 80 through the coupling port 86 is controlled. The control of displacing fluid flow from the displacing fluid reservoir 40 to the centrifuging chamber 80 can be accomplished by any of a variety of valves, preferably a one-way valve mechanism including, but not limited to, spring valves, resilient valve flap valves, which are remotely actuated or actuated under centrifugal force in response to a certain rotational speed, as well as externally actuated valves.

The outlet 84 of the centrifuging chamber 80 interfaces with a sampling stem 100. The sampling stem 100 can be integrally formed with the rotor assembly 10 or can be a separate component either removably or fixedly attached to the rotor assembly. The sampling stem 100 provides for presentation of the separated liquid components for aspiration, or withdrawal, from the rotor assembly 10. Preferably, the sampling stem 100 includes an aspirating chamber 102 for collecting and retaining a subvolume of the separated liquid expressed through the outlet 84 of the centrifuging chamber 80. Preferably, the aspirating chamber 102 is sized to permit temporary retention and collection of the anticipated volume of the desired separated component of the liquid. That is, if 30 ml of whole blood is processed, and the anticipated volume of the desired buffy coat layer is approximately 2 ml, the aspirating chamber 102 has a volume greater than 2 ml, and typically on the order of 4 to 5 ml.

In addition, referring, for example, to FIGS. 14, 15, 24, 24-27 and 31-33 and as set forth in the description of alternative embodiments, the sampling stem 100 can incorporate the displacing fluid reservoir 40.

The sampling stem 100 can include a dispensing valve 104 for selectively permitting passage of liquid from the outlet 84 of the centrifuging chamber 80 into the sampling stem. The dispensing valve 104 can be remotely actuated, such as by magnets. In sampling stem 100 can also include a cover 110 for sealing the stem as well as permitting limited access, as for example in aspiration of the separated components.

Depending on the desired configuration and operating parameters, it is contemplated that the separated blood components can be expressed from the centrifuging chamber 80 and into the sampling stem 100 by variety of mechanisms. For example, if the displacing fluid reservoir 40 is continually vented to ambient pressure, the dispensing valve 104 in the sampling stem 100 is selectively activated to allow the expression of a volume of separated liquid. Alternatively, if the sampling stem dispensing valve 104 is merely a check valve, the venting of the displacing fluid reservoir 40 is controlled, and the controlled venting of the displacing fluid reservoir can be used to allow passage of the separated liquid through the dispensing check valve.

Although a number of the components, including the displacing fluid reservoir 40, the centrifuging chamber 80, the coupling port 86 and the sampling stem 100 have been described as separate components, it is understood that the components can be monolithic or modular.

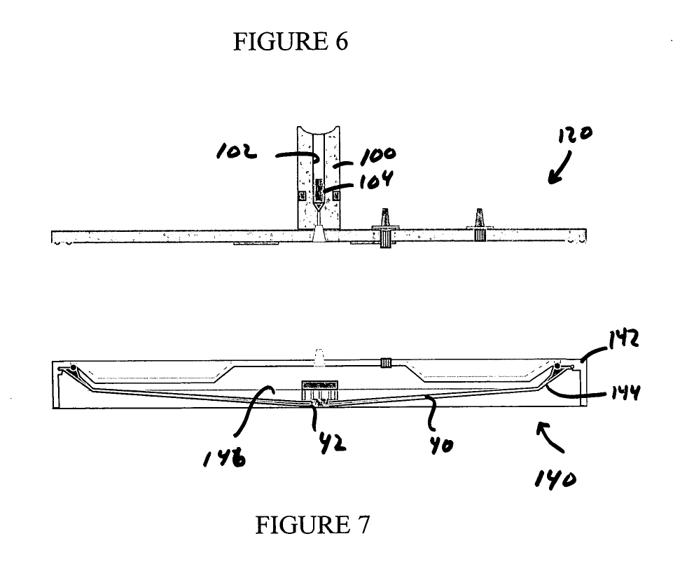

Referring to FIGS. 4-9, a rotor assembly 10 having the displacing fluid reservoir 40 below the centrifuging chamber 80 is shown. Referring to FIGS. 6 and 7, the rotor assembly 10 can be formed from an upper plate assembly 120 and a lower plate assembly 140.

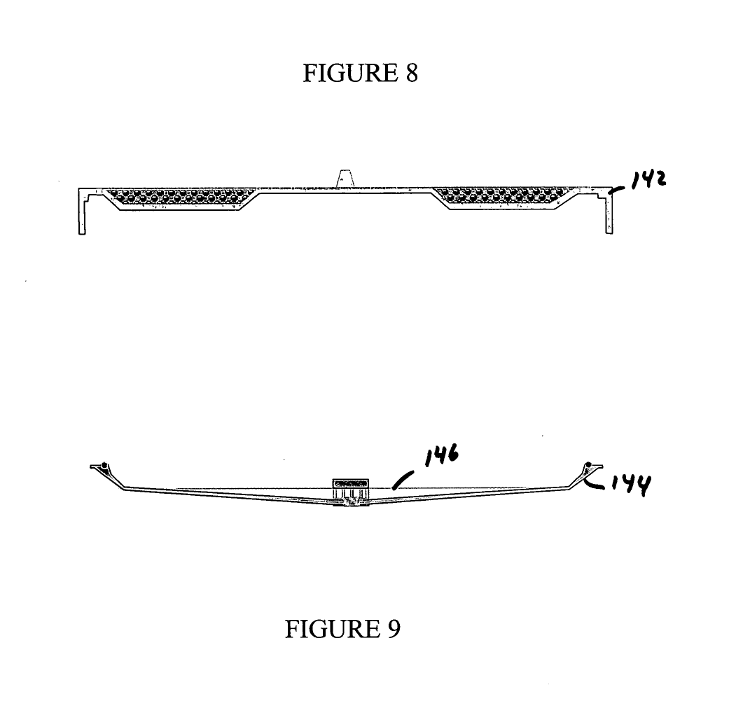

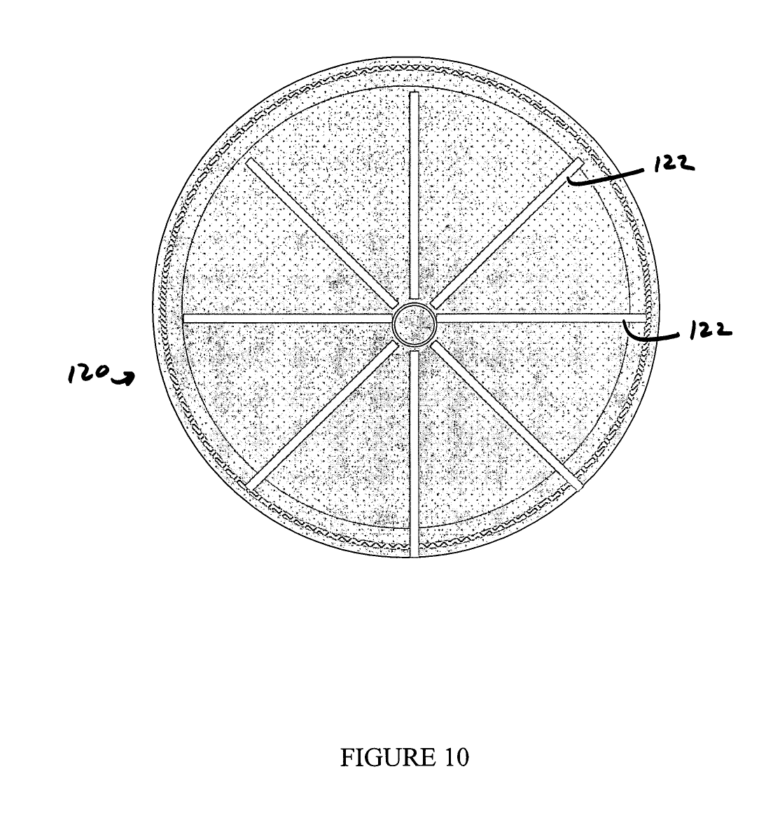

As seen in FIGS. 8 and 9, the lower plate assembly 140 can be formed from an upper shell 142 and a lower shell 144, wherein the upper shell defines a cavity substantially forming the centrifuging chamber, and the lower shell assembly defines the displacing fluid reservoir. The lower shell 144 can also include strengthening or stiffening ribs 140, which can be employed for displacing fluid control. In addition, the lower shell assembly includes or cooperates with, in those selected configurations, the venting port 42 for allowing the admission of ambient pressure as displacing fluid is urged from the displacing fluid reservoir 40. The shells of the lower plate assembly can be operably connected by any of a variety of mechanisms including chemical and mechanical interconnection including, but not limited to, thermal bonding, adhesion, ultrasonic welding, as well as friction fittings. It is contemplated that seals can be disposed between the shells to assist in directing the fluid. The seals can include O-rings having any of a variety of cross-sectional profile, as dictated by the intended operating parameters.

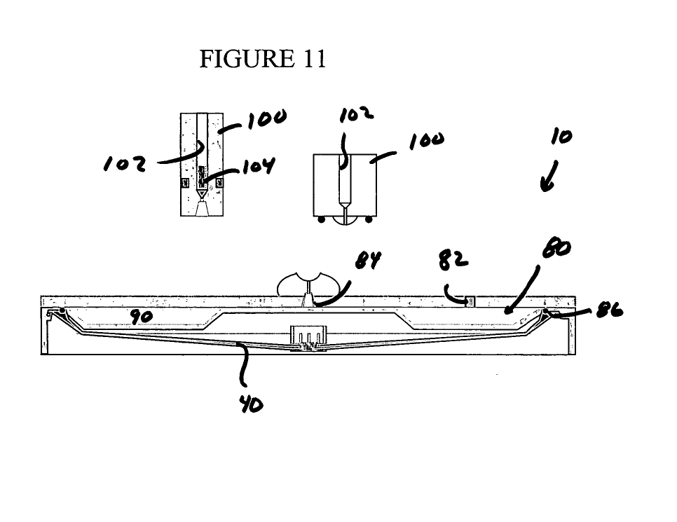

As shown in FIGS. 4-6, the sampling stem 100 can be integrally formed or connected to the upper plate assembly 120. Referring to FIG. 11, the sampling stem 100 can alternatively be constructed as a removable or interchangeable component.

As shown in FIGS. 14-16, 20, 24-29, and 33-35, the displacing fluid reservoir 40 can be disposed above the centrifuging chamber 80, wherein the displacing fluid reservoir is radially inward of the main body 90 of the centrifuging chamber.

As in the prior configurations of the rotor assembly 10, the centrifuging chamber 80 includes the outlet port 84 coincident with the axis of rotation 14, and the inlet port 82 for receiving the blood to be separated. Further, the coupling port 86 is located at the radial maximum of the centrifuging chamber 80.

In this configuration, the displacing fluid reservoir 40 has a generally cylindrical shape concentric with the axis of rotation, wherein the sampling stem 100 and the aspiration chamber 102 are circumscribed by the displacing fluid reservoir.

In this configuration, the displacing fluid in the displacing fluid reservoir is again selectively exposed to a maximum radial dimension of the centrifuging chamber 80. Generally, a plurality of radially extending flow paths connect the displacing fluid reservoir and the centrifuging chamber. Thus, a plurality of coupling ports 86 can exist between the displacing fluid receiver 40 and the centrifuging chamber 80.

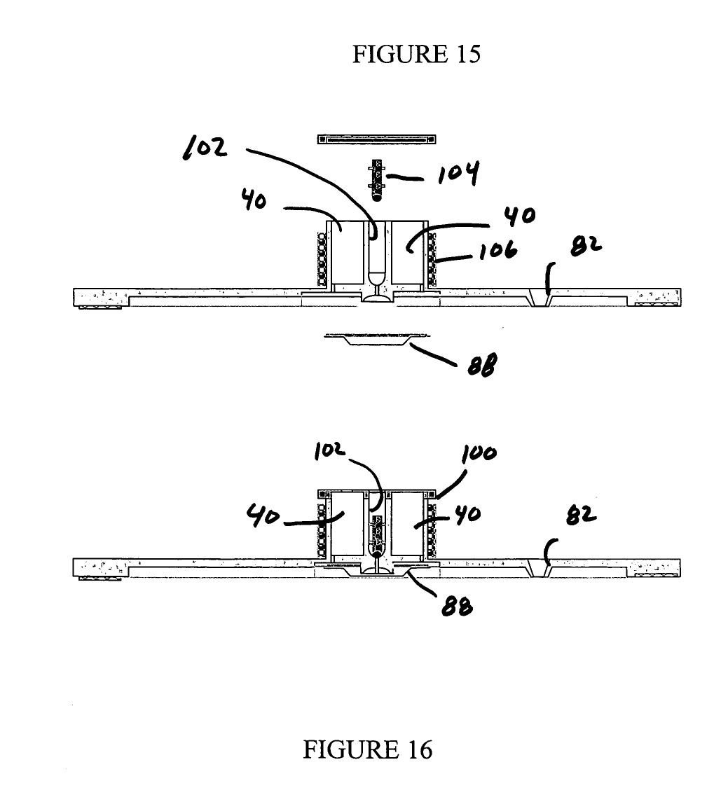

In this configuration, the rotor assembly 10 can be formed from an upper plate assembly 120′ and a lower plate assembly 140′. As seen in FIGS. 15 and 16, the upper plate assembly 120′ can include an integral or removable sampling stem 100, wherein the sampling stem defines the displacing fluid reservoir 40. The dispensing or outlet valve 104 is disposed within the sampling stem 100 to permit selective passage of fluid from the centrifuging chamber 80.

While the outlet valve 104 can have any of a variety of configurations, a remotely actuatable valve can include a magnetic poppet disposed within the sampling stem 100 and a plurality of wire coils 106 disposed about the displacing fluid reservoir, such that upon passage of an electric current through the windings, the poppet can be moved to provide an open and a closed position.

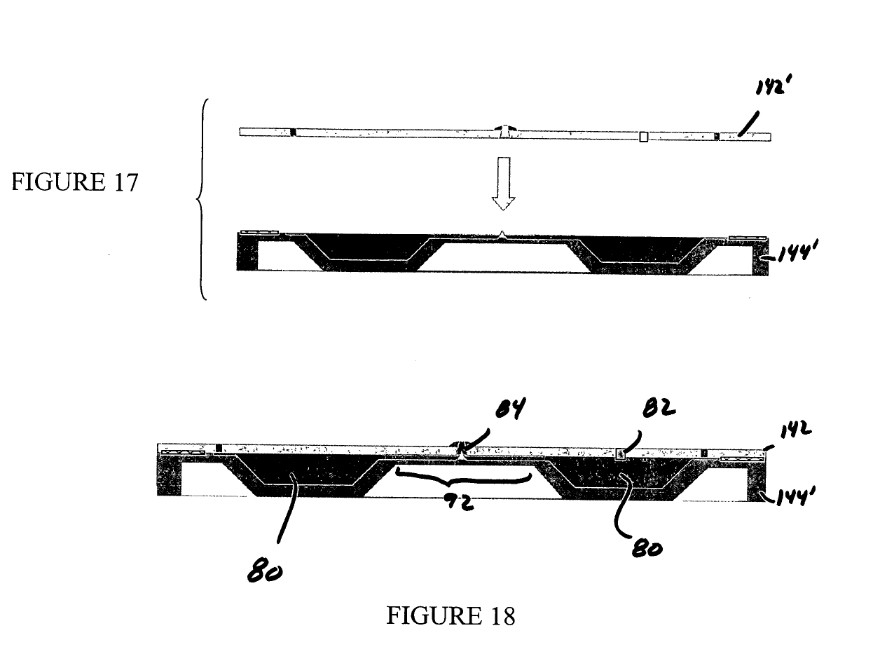

Referring to FIGS. 17 and 18, the lower plate assembly 140′ can include a lower shell 144′ generally defining the centrifuging chamber 80, wherein the upper shell or plate 142′ can be fastened to the bottom shell. The top shell can include the inlet port 82 for selectively filling the centrifuging chamber 80.

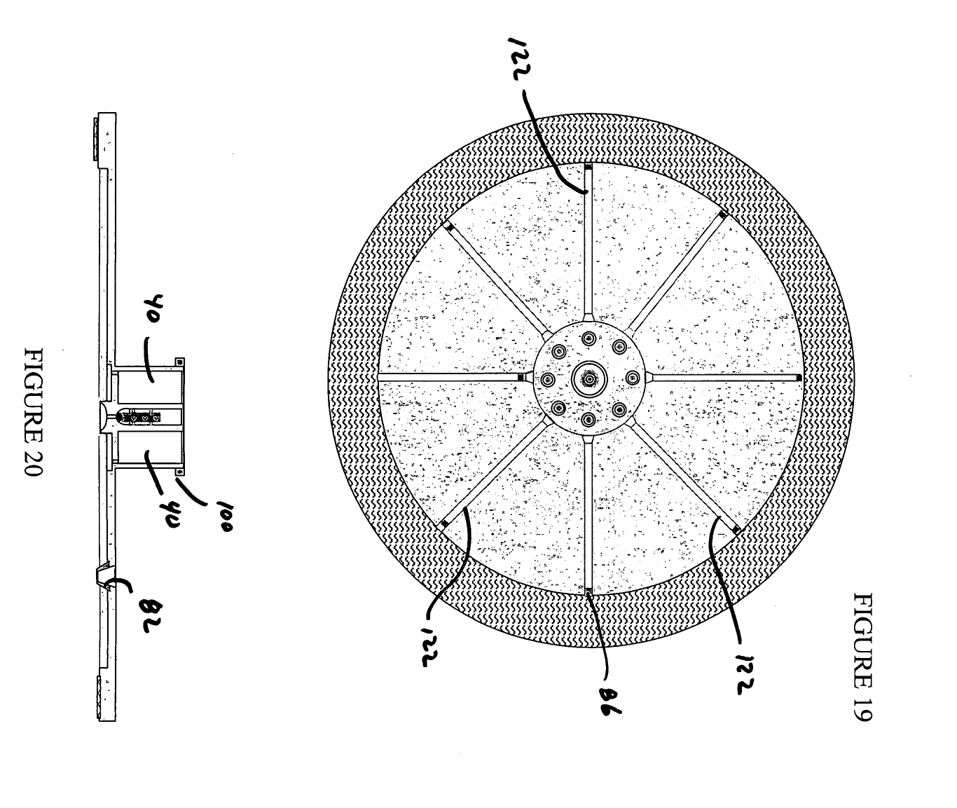

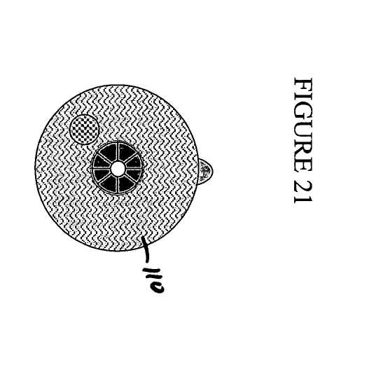

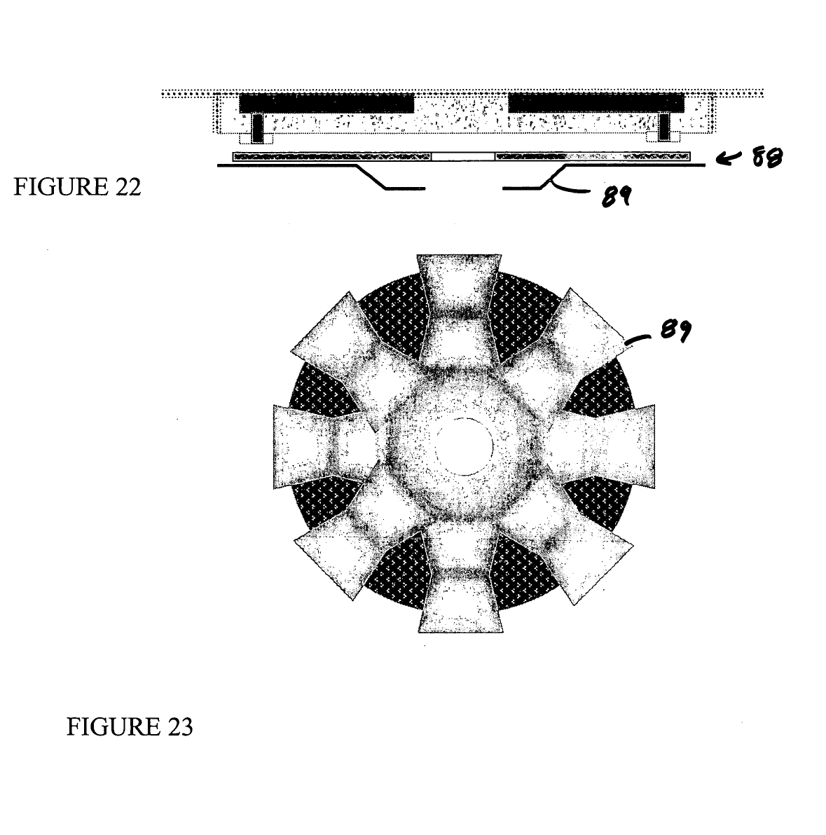

Referring to FIG. 19, a bottom view of the upper plate assembly 120′ is shown, wherein a plurality of radially extending channels 122 are shown for allowing transmission of the displacing fluid from the displacing fluid reservoir 40 to the coupling ports 86 and hence to the centrifuging chamber 80. As seen in FIGS. 22 and 23, a coupling valve 88 can be disposed adjacent the bottom of the displacing fluid reservoir 40 to selectively control transmission of the displacing fluid from the displacing fluid reservoir to the radial extending flow paths 122. It is contemplated that the coupling valve 88, shown as a spring metal plate 89 in FIGS. 22 and 23, can be of selected resiliency and material such that passage of the displacing fluid from the displacing fluid reservoir 40 occurs upon a generally predetermined rotation rate of the rotor assembly 10.

Thus, the rotor assembly is selected for rotation about an axis to separate components in a liquid, wherein the rotor assembly includes a centrifuging chamber 80 having an inlet port 82, a spaced apart outlet port 84 and a coupling port 86, the centrifuging chamber having a maximum radial dimension, a displacing fluid reservoir 40 having at least a portion of the reservoir radially inward of the maximum radial dimension of the centrifuging reservoir, and a displacing fluid in the displacing fluid reservoir, the displacing fluid having a greater density than the liquid. In a preferred construction, at least a portion of the displacing fluid reservoir 40 is radially inward of a portion of the centrifuging chamber 80.

Alternatively stated, the rotor assembly includes the centrifuging chamber 80 having a maximum radial dimension and an outlet port 84; an annular plate-like gradient amplification zone fluidly connected to the outlet port; the displacing fluid reservoir 40, the displacing fluid reservoir including an outlet; at least one radial channel fluidly connecting the outlet to the centrifuging chamber; and a check valve fluidly intermediate the outlet and the centrifuging chamber. The displacing fluid reservoir can include a cover having a passive filter vent to admit ambient pressure to the displacing fluid reservior.

In a further configuration, the rotor assembly includes the centrifuging chamber 80 having a maximum radial dimension, the fluid outlet port 84 being located radially inward of the maximum radial dimension of the centrifuging chamber and a port 86 for receiving the displacing fluid located radially outward of the fluid outlet port; and the displacing fluid reservoir 40 being located at least partially radially inward of the maximum radius of the centrifuging chamber, the displacing reservoir selectively fluidly connected to the displacing fluid port. It is understood the maximum radial dimension is independent of a centrifuging rotation rate of the rotor assembly about the axis.

### Operation

In operation, the fluid to be tested, or separated, such as whole blood is introduced into the centrifuging chamber 80. The introduction of the whole blood into the centrifuging chamber 80 can be accomplished by applying a slight pressure to the whole blood and venting the centrifuging chamber 80 to allow introduction of the whole blood of the centrifuging chamber. Alternatively, the introduction of the whole blood can be coupled with a reduced pressure in the centrifuging chamber to effectively draw the whole blood into the centrifuging chamber 80. It is further contemplated, the centrifuging chamber 80 can be at least partially evacuated, thereby providing a sufficient reduced pressure to drawing the blood into the centrifuging chamber.

Thus, the present rotor assembly 10 can be independent or cooperatively engaged with the caddy 12 wherein a negative pressure is created in the centrifuging chamber 80. Upon fluidly communicating the negative pressure centrifuging chamber 80 to a blood source (such as a patient), blood is drawn into the centrifuging chamber. By controlling the pressure in the centrifuging chamber 80, the introduction of blood into the centrifuging chamber can be controlled.

The caddy 12 can incorporate a vacuum source to induce flow into a rotor assembly 10 operably connected to the caddy. It is understood the caddy 12 can retain the rotor assembly 10 during configuration or merely assist in acquisition of the blood and transport.

The displacing fluid is disposed in the displacing fluid reservoir 40. The displacing fluid can be introduced into the displacing fluid reservoir prior to, concurrent or subsequent to the introduction of the blood into the centrifuging chamber 80. It is anticipated that manufacturing infeasibility considerations will suggest that the displacing fluid reservoir is filled prior to introduction of the blood to the centrifuging chamber. Displacing fluids can include a variety of liquids that have a greater specific gravity and the liquid to be separated in the centrifuge in chamber, and particularly the most dense component of the liquid to be separated. It is understood that the displacing fluid can be miscible or in immiscible in the liquid to be separated. The actual displacing fluid selected, is at least partially determined by the desired in miscible or immiscible relation with the liquid to be separated. That is, an immiscible displacing fluid can be introduced into the centrifuging chamber 80 at any radial location within the centrifuging chamber, as such introduction would not cause mixing of the displacing fluid and the liquid to be separated. However, it is understood such introduction may cause mixing of the previously separated liquid in the centrifuging chamber 80, as the heavier displacing fluid migrates to the maximum available radial dimension in the centrifuging chamber. It is further contemplated that displacing fluids which would otherwise be miscible in the liquid to be separated, can be introduced at the maximum radial dimension of the centrifuging chamber to express a portion of the separated liquid through the outlet port 84. Preferably, the displacing fluid does not separate into components or mix with the liquid in the centrifuging chamber. That is, a clear demarcation interface exists between the displacing fluid and the blood (liquid to be separated). A representative displacing fluid includes a mixture of dense sucrose and phosphate buffered saline (45% sucrose in PBS, having a density of approximately 1.22 g/ml compared to a density of approximately 1.11 g/ml for red blood cells). Depending upon the liquids to be separated, the displacing fluid can include a preservative such as azide in a concentration of approximately 0.1%. Alternatively, the displacing fluid can be a higher concentration of sucrose, such as approximately 60% thereby providing a specific gravity of approximately 1.29. It is further contemplated that displacing fluids which are immiscible in water, such as silicone fluids, having a specific gravity of approximately 1.8 can be employed.

Typically, the coupling port 86 is valved (closed) to preclude fluid flow from the centrifuging chamber 80 to the displacing fluid reservoir 40, as well as selectively permitting only one way flow from the displacing fluid reservoir to the centrifuging chamber. Prior to rotation, the rotor assembly 10 includes a volume of displacing fluid in the displacing fluid reservoir and whole blood in the centrifuging chamber, wherein fluid communication between the displacing fluid and the whole blood through the coupling port is precluded.

Rotation of the rotor assembly 10 about the axis 14 is initiated. Upon sufficient rotational velocity and time, the whole blood separates into layers. The layers are separated by interfaces parallel to the axis of rotation 14.

Upon desired separation of the components, which can be verified by timing (from experimental or prior knowledge) or sensed by any of the variety of sensors 34 including the optical sensors, the rotational velocity of the rotor assembly 10 can be reduced to a velocity sufficient to maintain the previously formed interfaces.

In principle, the displacing fluid, initially retained in the displacing fluid reservoir 40, has a greater density than the most dense component of the liquid in the centrifuging chamber 80. As the denser displacing fluid is initially radially inward of the relatively lighter whole blood (and the centrifuging chamber 80) during rotation, the displacing fluid is urged to the largest available radial volume. Upon passing through the coupling port 86 (and any associated coupling valve 88), the displacing fluid occupies the outmost portion of the centrifuging chamber 80, and the lightest separated liquid component in the centrifuging chamber is urged into (and through) the gradient amplification zone and hence adjacent the outlet port 84. Introduction of displacing fluid into the centrifuging chamber 80 urges the lightest components in the centrifuging chamber to the outlet port 84 and hence to the sampling stem 100.

Either during the separation rotational velocity or the reduced rotational velocity, the displacing fluid is allowed to pass through the coupling port 86 to the centrifuging chamber 80. The relatively heavy displacing fluid occupies a volume at the largest radial dimension in the centrifuging chamber 80. As the displacing fluid occupies the outer volume of the centrifuging chamber, the lightest separated component in the centrifuging chamber is urged into the gradient amplification zone 92.

As the separated components and interfaces sequentially occupy the gradient amplification zone 92, a relatively high resolution determination of the components can be made, prior to expression from the rotor assembly 10.

The expression of the lightest fluid component from the gradient amplification zone 92 in the centrifuging chamber 80 through the outlet port 82 is accomplished by either or any combination of (i) actuating the dispensing valve 104, (ii) controlling flow through the coupling port 86, or (iii) controlling venting of the displacing fluid reservoir 40.

The expressed separated fluid component pools in the sampling stem 100 and can thus be aspirated. The aspiration can be automated or manual.

It is also contemplated the rotor assembly 10 can include a disposable aspirator within the sampling stem 100, thus allowing all non-desired fluid to be retained within the rotor assembly. The rotor assembly 10 can be employed in conjunction with a stationary collection tube. Further, the separated liquid expressed from the rotor assembly 10 can be passed through a relatively small diameter tube to allow real-time examination (or characterization) of the passing separated liquid by any of a plurality of sensors such as optical, chemical or electrical. As the controller 26 can be operably connected to such sensors, the rotational velocity of the rotor assembly 10 can be adjusted to provide a controlled expression of the liquid.

The rotor assembly 10 can be provide a method of separating components in a biological fluid, by reducing a pressure in the centrifuging chamber 80; exposing the reduced pressure in the centrifuging chamber to a vivo source of the biological fluid, such as blood; and exposing a volume of a displacing fluid in a displacing fluid reservoir 80 in the rotor assembly to the biological fluid in the centrifuging chamber, the displacing fluid having a greater density than the biological fluid.

Further, the rotor assembly can be employed in a method for selectively expressing liquid from a rotating rotor, by passing the displacing fluid through the check valve 88 to fluidly communicate the displacing fluid with the centrifuging chamber 80; and opening the outlet valve 104 to pass a portion of the liquid through the outlet valve from the centrifuging chamber.

Alternatively, the rotor assembly 10 can be employed in a method for selectively expressing liquid by exposing the displacing fluid to an ambient pressure; passing at least a portion of the displacing fluid through the valve 88 to enter the centrifuging chamber 80; and selectively opening the outlet port valve 104 to pass a portion of the liquid from the centrifuging chamber.

The rotor assembly 10 can thus provide a method of centrifuging a liquid sample about an axis to separate components of the liquid sample by density into component layers, to form at least two layer-to-layer boundaries, by locating the at least two layer-to-layer boundaries in the centrifuging chamber 80; and simultaneously decreasing a radial location of each of the at least two layer-to-layer boundaries layers.

Further, the rotor assembly 10 provides a method of centrifuging a liquid, through rotating the toroidal centrifuging chamber 80 about an axis of rotation to separate components of a retained liquid by density into component layers, the centrifuging chamber having a radial dimension and an axial dimension; and removing a lowest density component layer from the centrifuging chamber through the outlet 84 by radially displacing a highest density component layer in the centrifuging chamber. In this method, the outlet 84 can be located along the axial dimension of the reservoir.

The rotor assembly 10 can be used in a method of removing a component layer from a rotating liquid sample having at least two component layers separated by an intermediate boundary layer in the centrifuging chamber 80 by radially translating the intermediate boundary layer in the centrifuging chamber to urge a portion of the sample into the outlet port 84, and particularly the lowest density portion of the sample into the outlet port. The rotor assembly can also locate the outlet port on an axis of rotation of the centrifuging chamber 80.

There is a relation among the difference in specific gravity of the displacing fluid and the liquid to be separated, the rotational velocity of the rotor assembly 10 and the resulting dispensing pressure (the pressure at the outlet port 84). That is, for a given rotational velocity of the rotor assembly 10, the greater the difference in specific gravity between the displacing fluid and the liquid in the centrifuging chamber 80, the greater the dispensing pressure. Alternatively, for a given difference in specific gravity between the displacing fluid and the liquid in the centrifuging chamber 80, the greater the rotational velocity of the rotor assembly 10, the greater the dispensing pressure.

Thus, the expression of separated components through the outlet port 84 can be controlled by a variety of mechanisms including the rotational velocity of the rotor assembly 10, the outlet valve 104, venting of the displacing fluid reservoir 40, as well as the coupling valve 88.

In prior blood separation techniques, a volume of blood is disposed in a cylindrical test tube and the test tube is rotated about a central axis, thereby separating the blood to form layers within the test tube, the layers being substantially perpendicular to the longitudinal axis of the test tube. This results in a relatively low resolution of the interfaces between the layers within the test tube. In contrast, the present rotor assembly 10 creates the interfaces between the component layers and separated blood as an annular surface, which is then passed through the gradient amplification zone 92, thereby increasing the resolution of the interfaces.

While the invention has been described in conjunction with specific embodiments thereof, it is evident that many alternatives, modifications, and variations will be apparent to those skilled in the art in light of the foregoing description. Accordingly, the present invention is intended to embrace all such alternatives, modifications, and variations as fall within the spirit and broad scope of the appended claims.

1. A centrifuging rotor assembly for rotation about an axis to separate components in a liquid, the centrifuging rotor assembly comprising:
(a) a centrifuging chamber having an inlet port and a spaced outlet port, the centrifuging chamber communicating with a coupling port;
(b) a displacing fluid reservoir located at least partially radially inward of the coupling port; and
(c) a coupling valve fluidly connected to the coupling port and the displacing fluid reservoir for selectively permitting fluid flow from the displacing fluid reservoir to the centrifuging chamber.

2. The centrifuging rotor assembly of claim 1, wherein at least a portion of the displacing fluid reservoir is radially inward of the centrifuging chamber.

3. The centrifuging rotor assembly of claim 1, wherein the coupling valve is deformable seal.

4. The centrifuging rotor assembly of claim 1, wherein the coupling valve is a leaf spring.

5. The centrifuging rotor assembly of claim 1, wherein the centrifuging chamber has a volume greater than approximately 30 ml.

6. The centrifuging rotor assembly of claim 1, further comprising a gradient amplification zone fluidly intermediate the centrifuging chamber and the outlet port, the gradient amplification zone having a smaller axial dimension than the centrifuging chamber.

7. The centrifuging rotor assembly of claim 1, further comprising a sampling stem fluidly communicating with the outlet port.

8. The centrifuging rotor assembly of claim 7, wherein the sampling stem is removably connected to the rotor assembly.

9. The centrifuging rotor assembly of claim 1, wherein the centrifuging chamber is a toroidal volume concentric with the axis of rotation.

10. A centrifugation rotor assembly for rotation of a liquid about an axis, the centrifugation rotor assembly comprising:
(a) a centrifuging chamber having a maximum radial dimension, a fluid outlet port located radially inward of the maximum radial dimension and a displacing fluid port located radially outward of the fluid outlet port; and
(b) a displacing fluid reservoir located at least partially radially inward of the maximum radius of the centrifuging chamber, the displacing fluid reservoir selectively fluidly connected to the displacing fluid port.

11. The centrifugation rotor assembly of claim 10, wherein the maximum radial dimension is independent of a centrifuging rotation rate about the axis.

12. The centrifugation rotor assembly of claim 10, wherein the centrifuging chamber is a volume of revolution.

13. The centrifugation rotor assembly of claim 10, wherein the centrifuging chamber is a toroid.

14. The centrifugation rotor assembly of claim 10, further comprising a coupling valve fluidly connected to the dispensing fluid reservoir.

15. The centrifugation rotor assembly of claim 10, further comprising a displacing fluid in the displacing fluid reservoir, the displacing fluid having a greater specific gravity than the fluid in the centrifuging chamber.

16. A centrifuging rotor assembly for rotation about an axis to separate components in a liquid, comprising:
(a) a centrifuging chamber for retaining a volume of the liquid; and
(b) a displacing fluid reservoir selectively fluidly coupled to the centrifuging chamber to communicate a displacing fluid to the volume of the liquid in the centrifuging chamber and occupy a maximum radial dimension of the centrifuging chamber.

17. The centrifuging rotor assembly of claim 16, further comprising a centrifugally actuated coupling valve intermediate the centrifuging chamber and the displacing fluid reservoir.

18. A centrifuging rotor assembly for separating components in a liquid, comprising:
(a) a centrifuging chamber having a dispensing port and a maximum radial dimension; and
(b) a displacing fluid reservoir, at least a portion of the displacing fluid reservoir being radially inward of the maximum radial dimension.

19. The centrifuging rotor assembly of claim 18, further comprising a displacing fluid in the displacing fluid reservoir, the displacing fluid having a density greater than the liquid.

20. The centrifuging rotor assembly of claim 18, further comprising a centrifugally actuated coupling valve fluidly intermediate the centrifuging chamber and the displacing fluid reservoir.

21. A rotor assembly for rotation about an axis, the rotor assembly comprising:
(a) a centrifuging chamber having a maximum radial dimension and an annular outlet;
(b) an annular plate-like gradient amplification zone fluidly connected to the annular outlet;
(c) a displacing fluid reservoir, the displacing fluid reservoir including an outlet port;
(d) at least one radial channel fluidly connecting the outlet port to the centrifuging chamber; and
(e) a check valve fluidly intermediate the outlet port and the centrifuging chamber for precluding fluid flow from the centrifuging chamber to the displacing fluid reservoir.

22. The rotor assembly of claim 21, further comprising a cover on the displacing fluid reservoir, the cover including a passive filter vent.

23. A centrifugation rotor assembly for rotation about an axis, the rotor comprising:
(a) a centrifuging chamber for retaining a volume of liquid, the centrifuging chamber including a variable maximum radial dimension, the maximum radial dimension being variable during rotation of the rotor about the axis.

24. The centrifugation rotor assembly of claim 23, wherein the dynamic maximum radial dimension is selectively controllable.

25. The centrifugation rotor assembly of claim 23, wherein the maximum radial dimension is independent of a centrifuging rotation rate about the axis.

26. The centrifugation rotor assembly of claim 23, wherein the centrifuging chamber is a volume of revolution.

27. The centrifugation rotor assembly of claim 23, wherein the centrifuging chamber is a toroid.

28. The centrifugation rotor assembly of claim 23, further comprising a displacing fluid reservoir being at least partially located radially inward of an inner radius of the centrifuging chamber.

29. The centrifugation rotor assembly of claim 28, further comprising a coupling valve fluidly connected to the centrifuging chamber and the displacing fluid reservoir for selectively providing fluid communication therebetween.

30. The centrifugation rotor assembly of claim 29, wherein the coupling valve is magnetically actuated.

31. The centrifugation rotor assembly of claim 28, further comprising a displacing fluid in the displacing fluid reservoir, wherein the displacing fluid has a greater density than a liquid in the centrifuging chamber.

32. A centrifuging rotor assembly for rotation about an axis to separate components of a retained liquid by density into component layers to form at least one liquid-to-liquid boundary layer located at a given radial distance from the axis, the centrifuging rotor comprising:
(a) a centrifuging chamber having a maximum radial dimension;
and
(b) means for decreasing the maximum radial dimension to decrease the given radial distance.

33. The centrifuging rotor assembly of claim 32, wherein the centrifuging chamber is a volume of revolution.

34. The centrifuging rotor assembly of claim 32, wherein the centrifuging chamber is a toroid.

35. The centrifuging rotor assembly of claim 32, wherein the means for decreasing the maximum radial dimension includes a displacing fluid reservoir located radially inward of the maximum radial dimension.

36. The centrifuging rotor assembly of claim 32, further comprising a remotely actuatable coupling valve fluidly intermediate the displacing fluid reservoir and the centrifuging chamber.

37. A method of centrifuging a liquid, comprising:
(a) rotating a volume of the liquid in a centrifuging chamber about an axis of rotation, the liquid having a given specific gravity; and
(b) selectively fluidly coupling a displacing fluid reservoir to expose a displacing fluid to the centrifuging chamber, the displacing fluid having a greater specific gravity than the liquid.

38. The method of claim 37 further comprising expressing a portion of the liquid from the centrifuging chamber in response to the fluid coupling of the displacing fluid reservoir and the centrifuging chamber.

39. A method for selectively expressing a liquid from a centrifuging chamber in a rotor rotating about an axis, the method comprising:
(a) exposing a volume of a displacing fluid in a displacing fluid reservoir in the rotor to the liquid in the centrifuging chamber, the displacing fluid having a greater density than the liquid.

40. The method of claim 39, further comprising:
(a) continuously exposing the displacing fluid to an ambient pressure; and
(b) selectively actuating a dispensing valve to pass liquid from the centrifuging chamber.

41. The method of claim 39, further comprising:
(a) selectively exposing the displacing fluid to an ambient pressure to control passage of the displacing fluid into the centrifuging chamber.

42. The method of any one of claims 39, 40 or 41 further comprising:
(a) locating the displacing fluid reservoir above the centrifuging chamber.

43. The method of any one of claims 39, 40 or 41 further comprising:
(a) locating the displacing fluid reservoir below the centrifuging chamber.

44. The method of any one of claims 39, 40 or 41 further comprising locating at least a portion of the displacing fluid reservoir radially inward of a portion of the centrifuging chamber.

45. A method of centrifuging a liquid sample about an axis to separate components of the liquid sample by density into component layers, to form at least two layer-to-layer boundaries, the method comprising:
(a) locating the at least two layer-to-layer boundaries in a centrifuging fluid reservoir; and
(b) simultaneously decreasing a radial location of each of the at least two layer-to-layer boundaries layers.

46. A method of centrifuging a liquid, the method comprising:
(a) rotating a toroidal centrifuging chamber about an axis of rotation to separate components of a retained liquid by density into component layers, the centrifuging chamber having a radial dimension and an axial dimension; and
(b) removing a lowest density component layer from the centrifuging chamber through an outlet by radially displacing a highest density component layer in the centrifuging chamber.

47. The method of claim 46, further comprising removing the lowest density component layer through an outlet port located along the axial dimension of the reservoir.

48. A method of separating components in a biological fluid, the method comprising:
(a) reducing a pressure in a centrifuging chamber of a rotor;
(b) exposing the reduced pressure in the centrifuging chamber to a vivo source of the biological fluid; and
(c) exposing a volume of a displacing fluid in a displacing fluid reservoir in the rotor to the biological fluid in the centrifuging chamber, the displacing fluid having a greater density than the biological fluid.
